(19) United States
(12) Patent Application Publication
(10) Pub. No.: US 2006/0236032 A1
(43) Pub. Date: Oct. 19, 2006

(54) Data storage system having memory controller with embedded CPU

(76) Inventors: Brian K. Campbell, Cedar Park, TX (US); Brian D. Magnuson, Somerville, MA (US); Ofer Porat, Westborough, MA (US); David L. Scheffey, Medway, MA (US); Clayton Curry, Waltham, MA (US)

Correspondence Address: RICHARD M. SHARKANSKY, PO BOX 557, MASHPEE, MA, 02649, US

(21) Appl. No.: 11/105,265

(22) Filed: Apr. 13, 2005

(51) Int. Cl. G06F 12/00

(52) U.S. Cl. 711/118

(57) ABSTRACT

A memory system includes a bank of memory, an interface to a packet switching network, and a memory controller. The memory system is adapted to receive by the interface a packet based command to access the bank of memory. The memory controller is adapted to execute initialization and configuration cycles for the bank of memory. An embedded central processing unit (CPU) is included in the memory controller and is adapted to execute computer executable instructions. The memory controller is adapted to process the packet based command.

### BACKGROUND OF THE INVENTION

1. Field of the Invention

The present invention relates data storage systems, and more particularly to data storage systems having cache memory controllers.

2. Brief Description of Related Prior Art

The need for high performance, high capacity information technology systems is driven by several factors. In many industries, critical information technology applications require outstanding levels of service. At the same time, the world is experiencing an information explosion as more and more users demand timely access to a huge and steadily growing mass of data including high quality multimedia content. The users also demand that information technology solutions protect data and perform under harsh conditions with minimal data loss. And computing systems of all types are not only accommodating more data but are also becoming more and more interconnected, raising the amounts of data exchanged at a geometric rate.

Servicing this demand, network computer systems generally include a plurality of geographically separated or distributed computer nodes that are configured to communicate with each other via, and are interconnected by, one or more network communications media. One conventional type of network computer system includes a network storage subsystem that is configured to provide a centralized location in the network at which to store, and from which to retrieve data. Advantageously, by using such a storage subsystem in the network, many of the network's data storage management and control functions may be centralized at the subsystem, instead of being distributed among the network nodes.

One type of conventional network storage subsystem, manufactured and sold by the Assignee of the subject application (hereinafter “Assignee”) under the tradename Symmetrix™ (hereinafter referred to as the “Assignee's conventional storage system”), includes a set of mass storage disk devices configured as one or more arrays of disks. The disk devices are controlled by disk controllers (commonly referred to as “back end” controllers/directors) that are coupled to a shared cache memory resource in the subsystem. The cache memory resource is also coupled to a plurality of host controllers (commonly referred to as “front end” controllers/directors). The disk controllers are coupled to respective disk adapters that, among other things, interface the disk controllers to the disk devices. Similarly, the host controllers are coupled to respective host channel adapters that, among other things, interface the host controllers via channel input/output (I/O) ports to the network communications channels (e.g., SCSI, Enterprise Systems Connection (ESCON), or Fibre Channel (FC) based communications channels) that couple the storage subsystem to computer nodes in the computer network external to the subsystem (commonly termed “host” computer nodes or “hosts”).

In the Assignee's conventional storage system, the shared cache memory resource comprises a relatively large amount of dynamic random access memory (DRAM) that is segmented into a multiplicity of cache memory regions. Each respective cache memory region may comprise, among other things, a respective memory array and a respective pair of memory region I/O controllers. The memory array comprised in a respective memory region may be configured into a plurality of banks of DRAM devices (which each such bank comprising multiple 64, 128, or 256 megabit DRAM integrated circuit chips) that are interfaced with the respective memory region's I/O controllers via a plurality of respective sets of command and data interfaces.

The I/O controllers in a respective memory region perform, based upon commands received from the host and disk controllers, relatively high level control and memory access functions in the respective memory region. For example, based upon commands received from the host and disk controllers, each I/O controller in a respective memory region may perform arbitration operations with the other I/O controller in the region so as to ensure that only one of the I/O controllers in the region is permitted to be actively accessing/controlling the memory array at any given time. Additionally, each I/O controller in a respective memory region may perform address decoding operations whereby a memory address supplied to the I/O controller by a host controller or a disk controller, as part of a memory access request (e.g., a memory read or write request) from the host controller or disk controller to the I/O controller, may be decoded by the I/O controller into a physical address in the memory region's memory array that corresponds to the address supplied by the host controller or disk controller. Other functions of the I/O controllers in a respective memory region include, among other things, temporary storage and transfer synchronization of data moving to and from the memory array in the respective region, and as will described more fully below, the handling of error conditions that may arise in the memory array.

Conversely, the command and data interfaces in a respective memory region perform, based upon commands received from the I/O controllers (e.g., via command/control signal busses coupling the I/O controllers to the interfaces), relatively low level control and memory access functions in the respective memory region. For example, these interfaces may provide, in response to a memory access request supplied to the interfaces from an I/O controller, appropriate chip select, clock synchronization, memory addressing, data transfer, memory control/management, and clock enable signals to the memory devices in the memory array that permit the requested memory access to occur.

When the memory array encounters an error condition, the command and data interfaces may detect the occurrence of the error condition and may report such occurrence to the I/O controller that currently is actively accessing/controlling the memory array (hereinafter termed the “active I/O controller”). Typical error conditions that may be detected and reported by the command and data interfaces include the occurrence of parity errors in the values transmitted by the command/control signal busses, the failure of a requested directed memory access to complete within a predetermined “timeout” period, etc.

In the conventional system, the I/O controller has limited or no computing intelligence and limited or no programmability such that most or all complex or programmable operations are executed from a processor that is external to the memory region. Additionally in the conventional system, a processor external to the memory region monitors the status of the region's memory array and I/O controller and performs regular maintenance/service on the memory array.

### SUMMARY OF THE INVENTION

In an aspect of the invention, a data storage system includes a first director being adapted for coupling to a host computer/server, a second director being adapted for coupling to a bank of disk drives, and a cache memory logically disposed between and communicating between the first and second directors. The cache memory includes a memory controller having an embedded central processing unit (CPU) being adapted to execute computer executable instructions.

In another aspect of the invention, a memory system includes a bank of memory, an interface to a packet switching network, and a memory controller. The memory system is adapted to receive by the interface a packet based command to access the bank of memory. The memory controller is adapted to execute initialization and configuration cycles for the bank of memory. An embedded central processing unit (CPU) is included in the memory controller and is adapted to execute computer executable instructions. The memory controller is adapted to process the packet based command.

In another aspect of the invention, a memory controller includes logic being adapted to execute initialization and configuration cycles for memory, an embedded central processing unit (CPU) being adapted to execute computer executable instructions, and an interface being adapted to access memory. The embedded CPU is adapted to access the memory in accordance with the computer executable instructions. The memory controller is adapted to access the memory, in response to direction from outside the memory controller, independently of processing by the embedded CPU.

One or more implementations of the invention may provide one or more of the following advantages.

Low latency access to global memory of a data storage system may be achieved by an embedded central processing unit (CPU) in a memory controller for the global memory. Multiple memory operations may be executed by the embedded CPU in less time than would be required by a CPU external to the memory controller.

Complex processing tasks that, absent the embedded CPU, would require processing by a CPU external to the memory controller may be performed by the memory controller itself. Other CPUs external to the memory controller, such as CPUs on directors of the data storage system, may offload complex processing tasks to the memory controller having the embedded CPU.

Monitoring and maintenance/service of the global memory and memory controller may be performed by the embedded CPU.

The embedded CPU may be partially or completely optional within the memory controller such that the memory controller may be fully operational for all or many essential memory controller operations without the embedded CPU.

The embedded CPU may have a programmable priority so that the CPU operations may be given different priority when arbitrating for the global memory depending on the task the embedded CPU is performing.

If the same operation needs to be done to multiple memory regions controlled by respective different multiple memory controllers, a message may be broadcast to all of the embedded CPUs in the memory controllers so that each memory controller can perform the operation in parallel with the other embedded CPUs.

Other advantages and features will become apparent from the following description, including the drawings, and from the claims.

### BRIEF DESCRIPTION OF THE DRAWINGS

FIG. 1 is a schematic block diagram of a data storage network that includes a data storage system wherein one embodiment of the present invention may be practiced to advantage.

FIG. 2 is a schematic block diagram illustrating functional components of the data storage system included in the data storage network shown in FIG. 1.

FIG. 3 is a schematic block diagram illustrating functional components of the shared cache memory resource of the data storage system of FIG. 2.

FIG. 4 is a schematic block diagram illustrating functional components of memory regions that may be comprised in the shared cache memory resource of FIG. 3.

FIG. 5 is a schematic block diagram of a memory controller that may be comprised in a memory region of FIG. 4.

FIG. 6 is a schematic block diagram of a central processing unit complex that may be comprised in the memory controller of FIG. 5.

FIGS. 7-8 are schematic block diagrams showing process flow within the central processing unit complex that may be comprised in the memory controller of FIG. 5.

FIG. 9-13 are schematic block diagrams of portions of a central processing unit of the central processing unit complex that may be comprised in the memory controller of FIG. 5.

### DETAILED DESCRIPTION

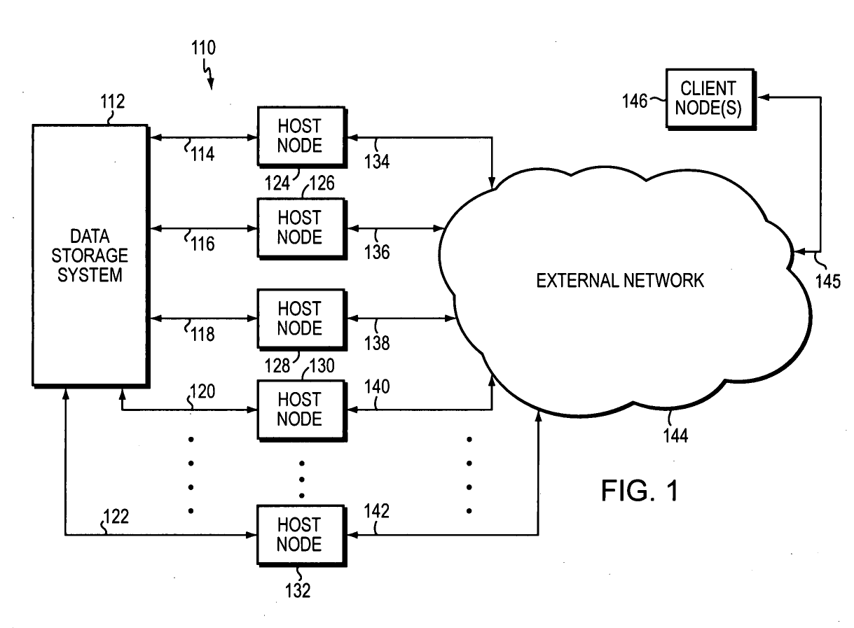

FIG. 1 is a block diagram illustrating a data storage network 110 that includes a data storage system 112 wherein at least one embodiment of the subject invention may be practiced to advantage. System 112 is coupled via communication links 114, 116, 118, 120, . . . 122 (which may be or include FC protocol optical communication links) to respective host computer nodes 124, 126, 128, 130, . . . 132. Host nodes 124, 126, 128, 130, . . . 132 are also coupled via additional respective communication links 134, 136, 138, 140, . . . 142 (which may be or include conventional network communication links) to an external network 144. Network 144 may comprise one or more Transmission Control Protocol/Internet Protocol (TCP/IP)-based and/or Ethernet-based local area and/or wide area networks. Network 144 is also coupled to one or more client computer nodes (collectively or singly referred to by numeral 146 in FIG. 1) via network communication links (collectively referred to by numeral 145 in FIG. 1). The network communication protocol or protocols utilized by the links 134, 136, 138, 140, . . . 142, and 145 are selected so as to help ensure that the nodes 124, 126, 128, 130, . . . 132 may exchange data and commands with the nodes 146 via network 144.

Host nodes 124, 126, 128, 130, . . . 132 maybe any one of several well known types of computer nodes, such as server computers, workstations, or mainframes. In general, each of the host nodes 124, 126, 128, 130, . . . 132 and client nodes 146 comprises a respective computer-readable memory (not shown) for storing software programs and data structures associated with, and for carrying out the functions and operations described herein as being carried by these nodes 124, 126, 128, 130, . . . 132, and 146. In addition, each of the nodes 124, 126, 128, 130, . . . 132, and 146 further includes one or more respective processors (not shown) and network communication devices for executing these software programs, manipulating these data structures, and for permitting and facilitating exchange of data and commands among the host nodes 124, 126, 128, 130, . . . 132 and client nodes 146 via the communication links 134, 136, 138, 140, . . . 142, network 144, and links 145. The execution of the software programs by the processors and network communication devices included in the hosts 124, 126, 128, 130, . . . 132 also permits and facilitates exchange of data and commands among the nodes 124,126, 128, 130, . . . 132 and the system 112 via the links 114, 116, 118, 120, . . . 122, in the manner that will be described below.

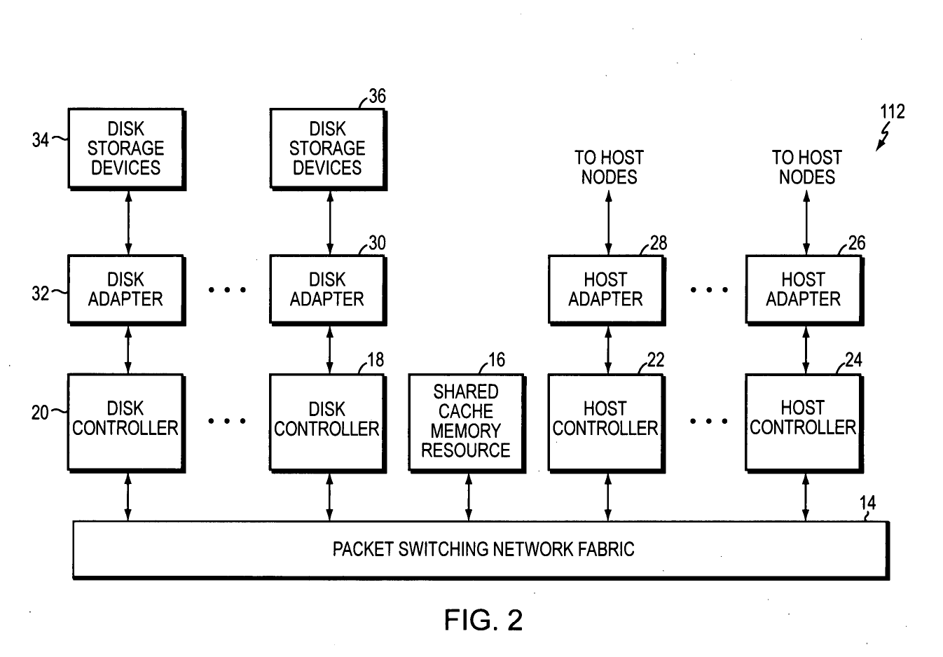

FIG. 2 is a block diagram of functional components of the system 112. System 112 includes a packet switching network fabric 14 that couples a plurality of host controllers (also referred to as front end directors) 22 . . . 24, a plurality of disk controllers (also referred to as back end directors) 18 . . . 20, and a shared cache memory resource 16 having multiple memory regions including regions 200, 202. Network fabric 14 is described in copending patent application Ser. No. 10/675,038 filed Sep. 30, 2003 entitled “Data Storage System Having Packet Switching Network” assigned to the same assignee as the present application, the entire subject matter thereof being incorporated by reference.

Each host controller 22 . . . 24 may comprise a single respective circuit board or panel. Likewise, each disk controller 18 . . . 20 may comprise a single respective circuit board or panel. Each disk adapter 30 . . . 32 shown in FIG. 2 may comprise a single respective circuit board or panel. Likewise, each host adapter 26 . . . 28 shown in FIG. 2 may comprise a single respective circuit board or panel. Each host controller 22 . . . 24 may be electrically and mechanically coupled to a respective host adapter 28 . . . 26, respectively, via a respective mating electromechanical coupling system.

In this embodiment of system 112, although not shown explicitly in the Figures, each host adapter 26 . . . 28 may be coupled to four respective host nodes via respective links. For example, in this embodiment of system 112, adapter 26 may be coupled to host nodes 124, 126, 128, 130 via respective links 114, 116, 118, 120. It should be appreciated that the number of host nodes to which each host adapter 26 . . . 28 may be coupled may vary, depending upon the particular configurations of the host adapters 26 . . . 28, and host controllers 22 . . . 24, without departing from the present invention.

Disk adapter 32 is electrically coupled to a set of mass storage devices 34, and interfaces the disk controller 20 to those devices 34 so as to permit exchange of data and commands between processors (not shown) in the disk controller 20 and the storage devices 34. Disk adapter 30 is electrically coupled to a set of mass storage devices 36, and interfaces the disk controller 18 to those devices 36 so as to permit exchange of data and commands between processors (not shown) in the disk controller 18 and the storage devices 36. The devices 34, 36 may be configured as redundant arrays of magnetic and/or optical disk mass storage devices.

It should be appreciated that the respective numbers of the respective functional components of system 112 shown in FIG. 2 are merely for illustrative purposes, and depending upon the particular application to which the system 112 is intended to be put, may vary without departing from the present invention. It may be desirable, however, to permit the system 112 to be capable of failover fault tolerance in the event of failure of a particular component in the system 112. Thus, in practical implementation of the system 112, it may be desirable that the system 112 include redundant functional components and a conventional mechanism for ensuring that the failure of any given functional component is detected and the operations of any failed functional component are assumed by a respective redundant functional component of the same type as the failed component.

The general manner in which data may be retrieved from and stored in the system 112 will now be described. Broadly speaking, in operation of network 110, a client node 146 may forward a request to retrieve data to a host node (e.g., node 124) via one of the links 145 associated with the client node 146, network 144 and the link 134 associated with the host node 124. If data being requested is not stored locally at the host node 124, but instead, is stored in the data storage system 112, the host node 124 may request the forwarding of that data from the system 112 via the link 114 associated with the node 124.

The request forwarded via link 114 is initially received by the host adapter 26 coupled to that link 114. The host adapter 26 associated with link 114 may then forward the request to the host controller 24 to which it is coupled. In response to the request forwarded to it, the host controller 24 may then determine (e.g., from data storage management tables (not shown) stored in the cache 16) whether the data being requested is currently in the cache 16; if it is determined that the requested data is currently not in the cache 16, the host controller 24 may request that the disk controller (e.g., controller 18) associated with the storage devices 36 within which the requested data is stored retrieve the requested data into the cache 16. In response to the request from the host controller 24, the disk controller 18 may forward via the disk adapter to which it is coupled appropriate commands for causing one or more of the disk devices 36 to retrieve the requested data. In response to such commands, the devices 36 may forward the requested data to the disk controller 18 via the disk adapter 30. The disk controller 18 may then store the requested data in the cache 16.

When the requested data is in the cache 16, the host controller 22 may retrieve the data from the cache 16 and forward it to the host node 124 via the adapter 26 and link 114. The host node 124 may then forward the requested data to the client node 146 that requested it via the link 134, network 144 and the link 145 associated with the client node 146.

Additionally, a client node 146 may forward a request to store data to a host node (e.g., node 124) via one of the links 145 associated with the client node 146, network 144 and the link 134 associated with the host node 124. The host node 124 may store the data locally, or alternatively, may request the storing of that data in the system 112 via the link 114 associated with the node 124.

The data storage request forwarded via link 114 is initially received by the host adapter 26 coupled to that link 114. The host adapter 26 associated with link 114 may then forward the data storage request to the host controller 24 to which it is coupled. In response to the data storage request forwarded to it, the host controller 24 may then initially store the data in cache 16. Thereafter, one of the disk controllers (e.g., controller 18) may cause that data stored in the cache 16 to be stored in one or more of the data storage devices 36 by issuing appropriate commands for same to the devices 36 via the adapter 30.

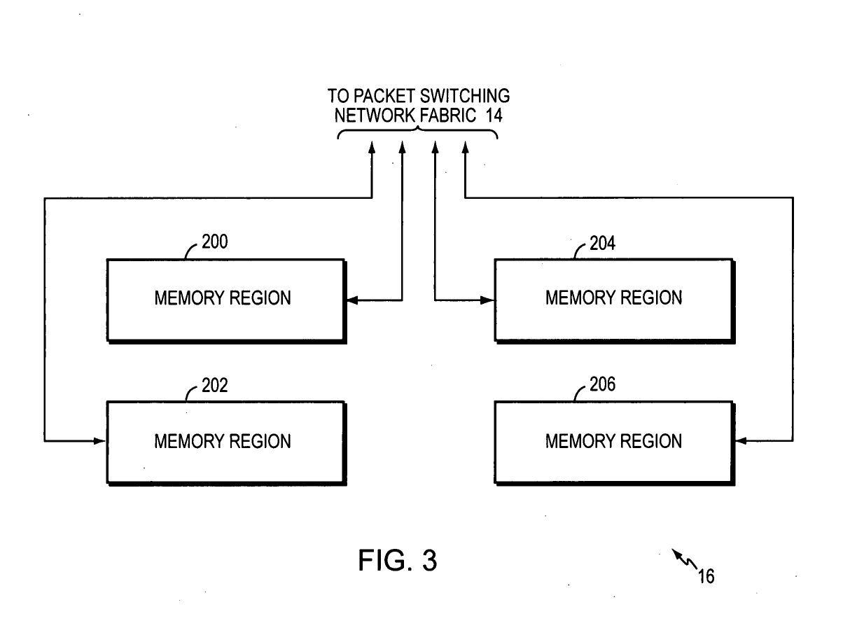

With particular reference being made to FIGS. 3-5, illustrative embodiments of the present invention that may be used to advantage in the cache memory 16 of the system 112 will now be described. Cache memory 16, also referred to as global memory (GM), is segmented into a plurality of memory regions 200, 202, 204, and 206. Each of these regions 200, 202, 204, 206 is coupled to network fabric 14. It is important to note that although not shown in the Figures, in practical implementation of system 112, the actual number of the memory regions into which the memory 16 is segmented may be significantly greater (e.g., 2 to 4 times greater) than the four regions 200, 202, 204, 206 shown in FIG. 3.

The memory regions 200, 202, 204, 206 may be essentially identical in their respective constructions and operations. Accordingly, in order to avoid unnecessary redundancy in the Description, the functional components and operation of a single one 200 of the memory regions 200, 202, 204, 206 will be described herein.

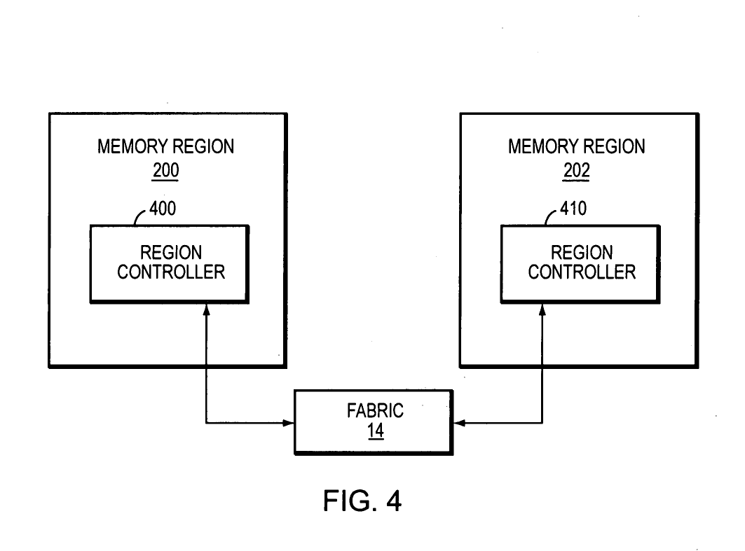

FIG. 4 depicts memory regions 200, 202 which include respective region controllers (RCs) 400, 410 described below, each of which RC is or includes a memory controller application specific integrated circuit (ASIC).

In at least one embodiment, a memory module (MM) of the data storage system has a main printed circuit board and a mezzanine printed circuit card, each of which has one memory region (or memory array) having, for example, 8 GB (using 512 Mb DRAMs). Each memory array 200 or 202 is controlled by its respective RC 400 or 410. Each RC receives requests and generates responses for data storage system cache memory operations, referred to as global memory (GM) operations, involving its respective memory region.

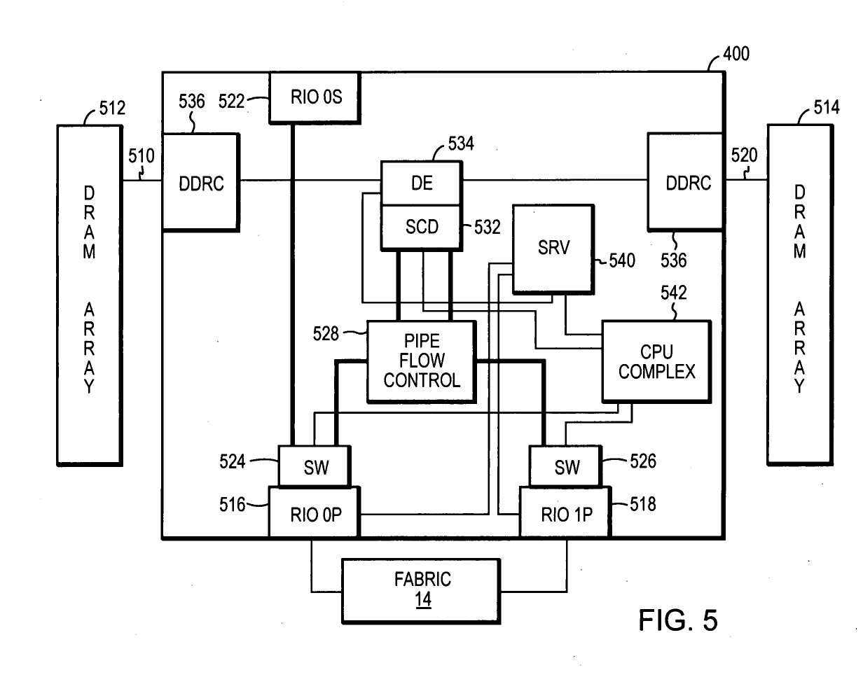

FIG. 5 shows a block diagram of RC 400, which has two data interfaces 510, 520 to respective DRAM arrays 512, 514 that are included in memory region 200 controlled by RC 400.

Each RC includes at least the following functional modules: primary RapidIO™ standard (RIO) end points 516, 518 (also denoted RIO0P, RIO1P), secondary RIO end point 522 (also denoted RIO0S or 2nd RIO E.P.), RIO switch sets 524, 526, pipe flow controller (PFC) set 528, scheduler 532 (also denoted SCD), data engine 534 (also denoted DE), Double Data Rate 2 standard synchronous dynamic random access memory (DDR2 SDRAM) controller (DDRC) set 536, and service logic 540 (also denoted SRV). These functional modules are described in copending patent application Ser. No. ______ filed Apr. ______, 2005 entitled “Queuing And Managing Multiple Memory Operations During Active Data Transfers” assigned to the same assignee as the present application. Each RC receives requests and generates responses for RIO messages, sends RIO messages, processes service requests, routes RIO requests upstream to the next RC, if any, in a daisy chain of RCs, if the destination specified in the message does not does not match the current RC, and routes RIO responses downstream towards fabric 16.

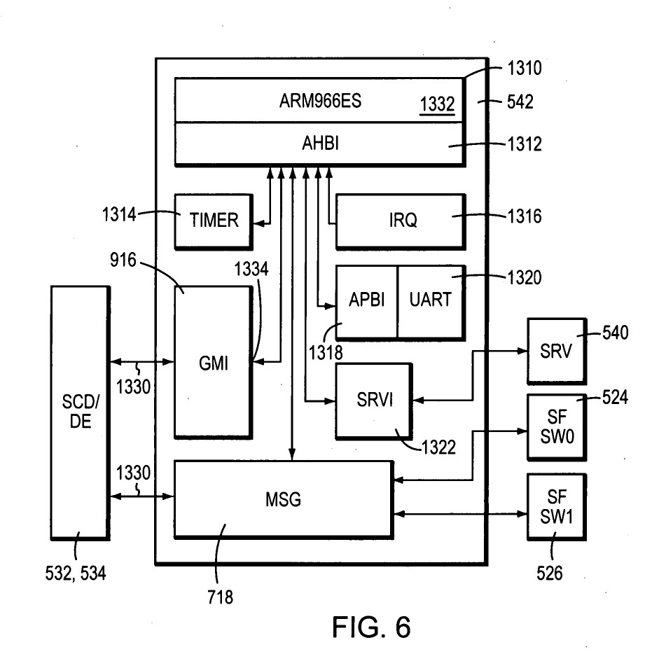

FIG. 5 also shows that the RC includes central processing unit (CPU) complex 542. In particular, the RC features an embedded CPU that has access to all or nearly all of the resources of the RC. With reference to FIG. 6, this access is enabled by CPU complex 542 which is a set of logic modules and which includes the following functionality described in more detail below: a CPU 1310 with tightly coupled memories, Advanced High-Performance Bus interface (AHBI) logic 1312 which serves as an interface from the CPU to peripherals, timer 1314 which provides timekeeping services to CPU 1310, interrupt controller logic 1316 (denoted IRQ), Advanced Peripheral Bus interface (APBI) 1318 providing a bridge to an Advanced Peripheral Bus (APB), UART 1320, service interface (SRVI) logic 1322, GMI logic 916, message engine 718, scheduler (SCD) and data engine 532, 534, service (SRV) logic 540, and store and forward portions (S&F RIOSW0, S&F RIOSW1) of switch sets 524, 526. Advanced High-Performance Bus and Advanced Peripheral Bus are protocols of Advanced Microcontroller Bus Architecture (AMBA) which is an open standard on-chip bus specification and is described by ARM, Inc. of Austin, Tex. (http://www.arm.com).

The CPU complex decodes accesses received over an Advanced High-Performance Bus (AHB) bus from the CPU and dispatches a corresponding request to the appropriate module or interface. The modules and interfaces that are available from the AHB are GMI 916, message engine 718, service interface 322, APBI and UART logic 1318, 1320, interrupt controller 1316, and timer 1314.

CPU 1310 sends and receives RIO messages through message engine 718. As messages arrive at the RC from the rest of the data storage system they are placed in an inbound message ring as described below and the CPU is informed of this through an interrupt. Likewise, the CPU can build messages in one of two outbound message rings to be sent by setting an indication to message engine 718.

Global memory interface (GMI) 916 gives CPU 1310 access to the portion of global memory directly attached to the RC. Interface SRVI 1322 allows the CPU to get and set the state of the RC's internal registers. UART 1320 provides a debugging path for software, timer 1314 is used for software scheduling, and interrupt controller 1316 is used to manage interrupt sources.

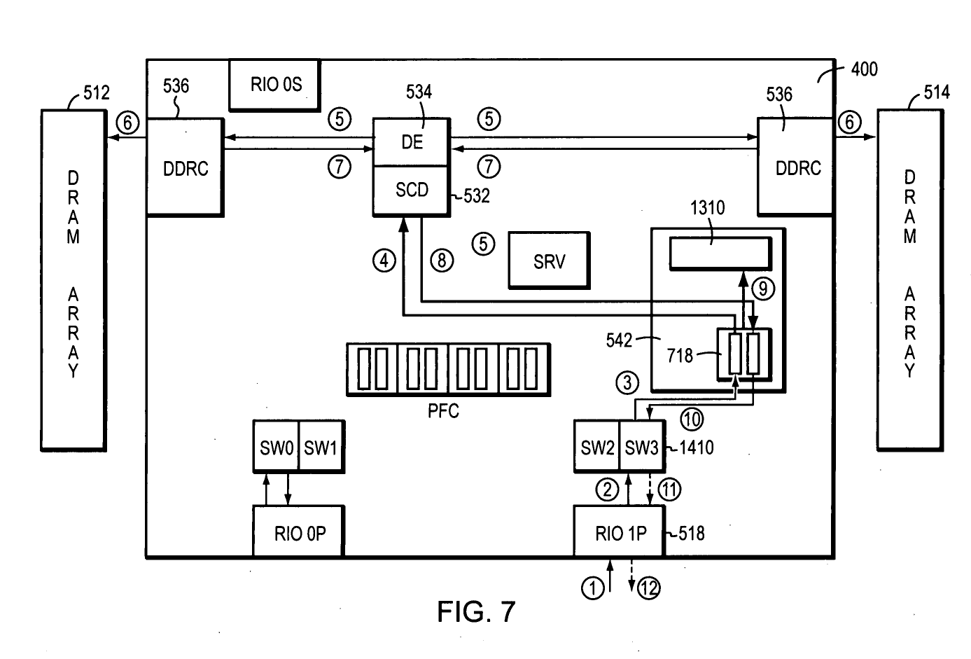

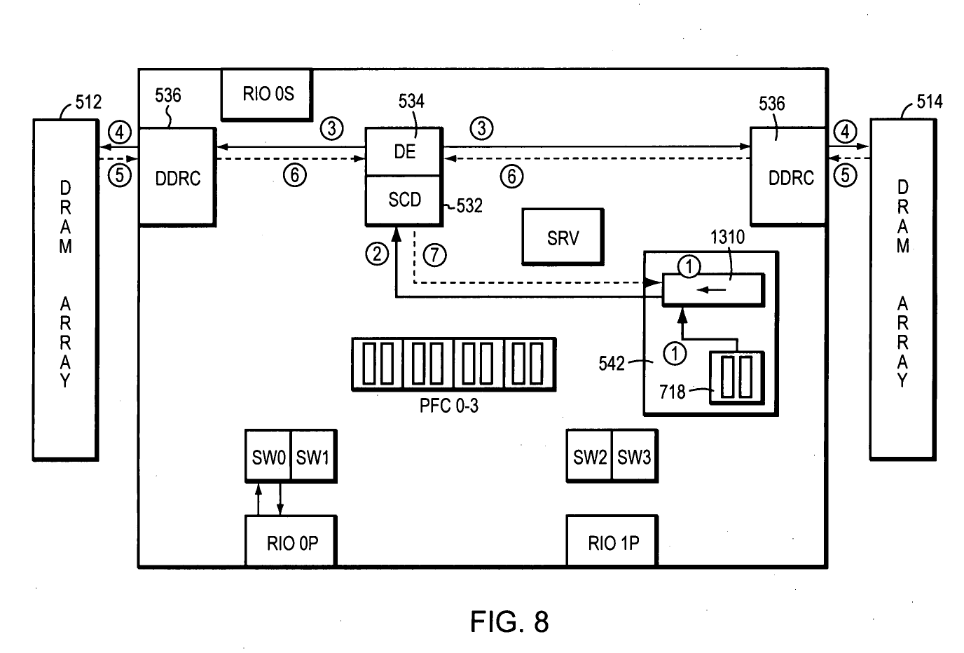

Multiple operations handled by the RC involve or potentially involve the CPU. Receiving and responding to messages involves the routing of a RIO message to the DRAM array, sending back a RIO message response, and the CPU GMI accessing the DRAM array, as shown at least in part by FIG. 7 for a receipt/process message operation sequence, and FIG. 8 for CPU access to global memory. With respect to a message access sequence depicted in FIG. 7, the routing of a message packet to global memory, and the consequential response, is to a large extent similar to that of a regular global memory operation (an operation that does not involve the CPU).

With reference to FIG. 7, a RIO packet is received and processed by end point RIO1P (FIG. 7 arrow 1). In this case RIO end point 518 recognizes the packet as a S/F packet and forwards it to S/F RIO switch SW2 1410 of switch set 526 (FIG. 7 arrow 2). The packet's destination header field is checked for proper routing; in this case it is routed to message engine 718 in CPU complex 542 (FIG. 7 arrow 3). The packet is received by message engine 718, which processes the packet similarly to a PFC module: the packet's header and payload are stored in synchronizing FIFOs to be transferred from the RIO clock (156.25 MHz) to the DDR clock (200 MHz). Message engine 718 also checks the integrity of the packet header.

The message engine 718 requests access to data engine 534 through scheduler 532. Once access is granted, the packet is processed by data engine 534 (FIG. 7 arrow 4) which moves the data to DDRC 536 for a write operation (FIG. 7 arrow 5). The DDRC performs the write operation to DRAM array 512, 514 (FIG. 7 arrow 6). Status is sent to data engine 534 (FIG. 7 arrow 7). Data engine 534 sends back status information to message engine 718 (FIG. 7 arrow 8). Message engine 718 gets the status/data from data engine 534, synchronizes it from 200 MHz to the 156.25 MHz clock, prepares the response packet, and requests access back to the RIO endpoint through the switch SW3 1410 (FIG. 7 arrow 10). In addition, message engine 718 sends an interrupt to CPU 1310 to inform CPU 1310 of the stored message (FIG. 7 arrow 9). Once switch 1410 grants the access, it routes the response packet back to RIO end point 518 (FIG. 7 arrow 11). RIO end point 518 sends the packet to the fabric (not shown) (FIG. 7 arrow 12).

With respect to a CPU—GM access sequence depicted in FIG. 8 flowchart, once CPU 1310 receives the interrupt signal from message engine 718 (FIG. 8 arrow I), the following actions are taken. The CPU its GMI to initiate memory access (FIG. 8 arrow 1). GMI decodes the CPU command and sends a request to scheduler 532 (FIG. 8 arrow 2). The scheduler grants access, and triggers the data engine. The data engine sends a read command to DDRC 536 (FIG. 8 arrow 3) which performs the read operation (FIG. 8 arrow 4). The read data is sent to DDRC 536 (FIG. 8 arrow 5), and the read data and status is sent to data engine 534 (FIG. 8 arrow 6).

The DE checks for data integrity and sends the data to GMI (FIG. 8 arrow 7) which sends the data to CPU.

With respect to generating and sending messages, CPU 1310 can construct a message and send it to fabric 14. The sequence of actions is largely a reverse of the receipt/process message operation. The CPU performs a write operation to GMI 916, and notifies message engine 718. Message engine 718 performs a read operation from the global memory, prepares the packet, and sends it to fabric 14.

With reference to FIG. 6, through its external interfaces CPU complex 542 interacts with modules outside of the CPU complex. Through the scheduler interface set 1330 the CPU complex performs reads and writes to global memory. The scheduler is the arbiter for access to the DRAM devices connected to the RC. The CPU complex has two interfaces to scheduler 532 because it contains two requesters: message engine 718 and GMI 916.

Service interface 1322 provides a means for accessing internal registers of the RC as well as each of four RIO end point internal registers. Service interface 1322 also delivers error information to these internal registers. In particular, service interface 1322 provides access to five areas of the RC from either of the two primary RIO end points or from CPU complex 542. These areas are RC internal registers (status, error, and configuration registers), internal 12C controller core (for external temperature sensors and VPD), internal registers of the primary RIO end points (RIO error, status and configuration, SERDES registers), internal registers of secondary RIO end points, and DDR training logic. I2C stands for Inter-Integrated Circuit and refers to a well known two-wire bi-directional serial bus technology.

In at least one embodiment, CPU 1310 does not have direct access (i.e., access other than through fabric 14) to memory attached to other RCs.

AHB interface (AHBI) 1312 is responsible for translating requests it receives from CPU core 1332 and issuing them to attached peripherals. Interface 1312 implements an AHB slave which connects to the AHB bus on one side and has independent connections on the other side to destinations that include APB interface 1318, timer 1314, interrupt controller 1316, service interface 1322, message engine 718, and GMI 916. For each AHB transaction it decodes which of the destinations is the subject of the transaction, forwards the request to the subject destination, and awaits a response. Once it receives the response it finishes the transaction on the AHB.

More particularly, the AHB interface acts as an address decoder by translating requests received from the CPU over the AHB bus and dispatching them to each of the available interfaces. The correct peripheral destination is determined from decoding the address of the request. Once the address has been decoded the AHBI selects the addressed interface by assertion of its select signal. After each transaction the destination indicates either success or failure.

In at least one embodiment all of the global memory connected to the RC is accessed through multiple of 256 MB windows. Through the programming of a window register, the CPU has access to sections of global memory. To reduce memory contention data may be cached by GMI 916 as described below so that further reads directed to corresponding regions of global memory do not necessarily trigger full global memory accesses.

Other windows are available for accessing message rings as described below. The base of each window is translated to the base address of the accessed ring. There is a separate cache maintained for the message rings apart from that for generic global memory accesses.

As shown in FIG. 6 GMI 916 has two interfaces: AHB interface 1334 on which all CPU read and write requests are sent and received, and scheduler interface 1330 which is used when a request received from AHB interface 1334 cannot be serviced out of GMI's cache and requires access to global memory.

Read and write accesses to GMI 916 can come from 4 different windows: a global memory window, a receive ring window, and a transmit ring window. The window to which the request is made affects the behavior of GMI 916.

Access to the global memory window uses the contents of a window register along with the specific address within the window to determine the address in global memory to access. If the corresponding data is in GMI's cache it is returned from the cache. Otherwise GMI 916 fetches the data from global memory.

The message windows operate similarly to the global memory window except that global memory addresses are calculated as an offset from a base register located in message engine.

GMI's cache may be or include two separate 64 byte caches. In at least one embodiment, consistency between the cache and global memory is not guaranteed, so that if global memory corresponding to the contents of the cache is modified through RIO communication by another CPU, no indication of this is made to embedded CPU 1310.

Further in at least one embodiment, there is no guarantee of consistency between the two 64 byte caches internally. The caches can be configured to cache reads or writes, or reads and writes. The caches can also be directed to flush or invalidate the cache.

As shown in FIG. 6, message engine 718 has four interfaces: one to each of the switch sets 524, 526 for reading data from and writing data to RIO end points; a scheduler interface for sending messages to and fetching messages from global memory; and a connection to AHB interface 1312 for a ring manager.

In at least one embodiment, all incoming messages from both switch set 524, 526 are placed in a single incoming ring. For outbound messages, two rings are defined. Messages from one of the two rings are directed to one switch set, and messages from the other of the two rings are directed to the other switch set.

The message rings are defined through a base address and a size. Work on these rings is defined by a pair of indices known as the producer and consumer indices. When these two indices are equal there is no work to be done. A producer creates work by first writing data into the next message slot after the current producer index. Once this data has been written the producer index is incremented to indicate the presence of the new work. The consumer processes the data in this slot and then increments the consumer index to reflect that the data has been processed. Until the consumer index is incremented that message slot cannot be used for another message.

The RC has an incoming ring and an outgoing ring. The outgoing ring is dedicated to sending message out of the end points 516, 518. For the incoming ring the RC is the producer and CPU 1310 is the consumer. For the outgoing ring the relationship is reversed so that the CPU is the producer and the RC is the consumer.

After a packet has been received message engine 718 requests access to global memory through scheduler 532, and once access is granted, delivers the packet into the next entry of the incoming message ring. An RX message ring producer index is then incremented and an interrupt is delivered to the CPU to indicate the arrival of a new message. The first four words of the message are a descriptor for the message.

Depending on the type of the packet delivered, a message response packet is queued. When an outgoing slot is available, the response packet's payload is written into that slot. The status field of the response packet contains information on the success or failure of the message delivery.

If a TX consumer index does not equal a corresponding producer index, message engine 718 determines that a packet is waiting to be sent into global memory. Under this condition message engine 718 reads out the first eight global memory words at the next consumer index, referred to as the message descriptor. Based on this descriptor, the message engine fetches the remainder of the message and stores it in an outgoing slot.

Whenever a packet is available for transfer, either after an outgoing packet had been fetched by the message engine, or a message response has been created, a request is made to switch set 524 or 526. The request and grant are separate for the two paths (CPU response and message engine response), but the data path is shared. Once arbitration is won the whole contents of the packet are sent to end point 516 or 518.

In a least one embodiment CPU 1310 is or includes an ARM966E-S embedded microprocessor available from ARM, Inc. of Austin, Tex. (http://www.arm.com/). The ARM966E-S microprocessor is a cache-less 5-stage machine with interfaces to internal, tightly coupled memories (TCMs), and AHB interface 1312, and is described in the ARM966E-S Technical Reference Manual (ARM DDI 0213C), ARM9E-S Technical Reference Manual (ARM DDI 0240A), and AMBA Specification (ARM IHI 0011A), available from ARM, Inc.

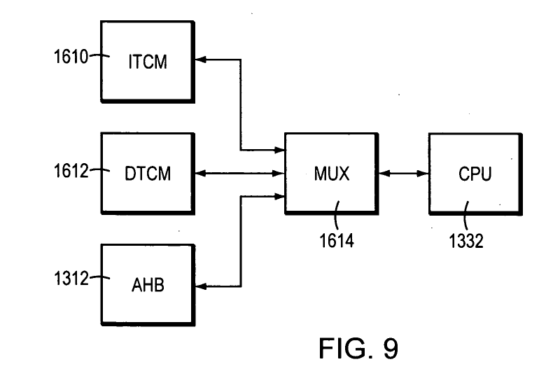

With reference to FIG. 9, CPU core 1332 has, via multiplexor 1614, two means of fetching instructions and data: (1) Instruction Tightly Coupled Memory (ITCM) 1610 and Data Tightly Coupled Memory (DTCM) 1612 which are a fast, local data store, and (2) AHB interface 1312 over which the CPU has access to a larger memory and any available peripherals. ITCM 1610 and DTCM 1612 can provide storage for both instructions and data for the CPU core, which can free the CPU from having to issue requests over AHB interface 1312 for each instruction which would significantly reduce performance. Otherwise, memory accesses occur over the AHB bus which interfaces to the AHB slave present in the AHBI, which services the request.

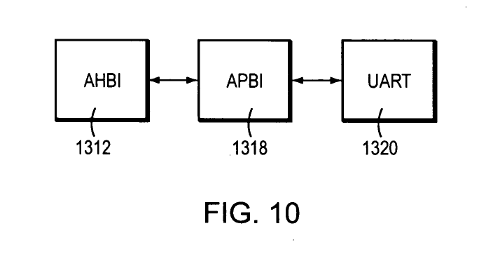

As shown in FIG. 10, APB interface 1312 is used for accessing APB connected peripherals; in CPU complex 542 UART 1320 is the only APB peripheral. The APB interface accepts requests from the AHB interface and translates them to requests over the APB bus, i.e., acts as a bridge between the AHB interface and the APB bus. Each time the APB interface is selected, the operation specified on the AHB side is translated into the corresponding APB operation. The APB bus is a 50 MHz interface that is synchronous with the 200 MHz system clock, which eases synchronization between the two domains. Data flow details are provided in the above referenced AMBA specification (ARM IHI 0011A).

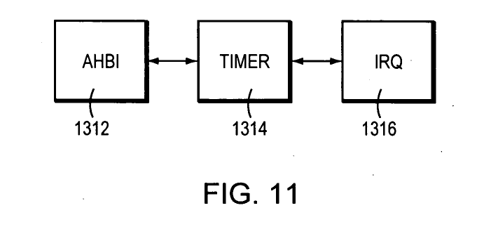

FIG. 11 illustrates timer 1314 which is or includes a programmable timer that can be used to generate interrupts to the CPU on a periodic basis. The timer implements a reloading 32 bit counter that generates an interrupt each time the counter reaches 0 and rolls back to a configured value. The timer counts 200 MHz clock cycles up to a maximum of 2³², which gives a granularity of 10 ns intervals from 10 ns to 42.94s.

Interrupt controller 1316 receives input from multiple interrupt sources and drives two interrupt lines to the CPU. The controller can then be interrogated to determine the specific source of the interrupt. Interrupt sources can also be masked to prevent them from interrupting the CPU. Whether an interrupt is delivered to the CPU as a regular interrupt or a fast interrupt is determined by a set of registers internal to interrupt controller 1316.

In particular, the interrupt controller monitors its inputs (IRQ ports) for high levels. Whenever these conditions are detected either a signal is asserted to the CPU based on a configuration register, if not masked.

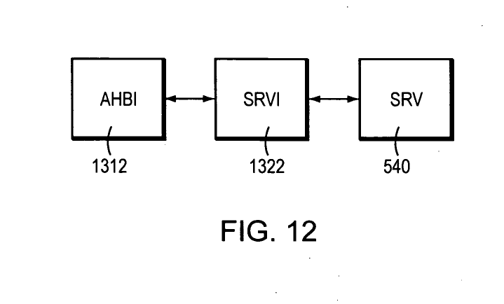

FIG. 12 illustrates service interface 1322 which is the means for accessing the RC-wide internal registers, delivering relevant error information and receiving configuration information.

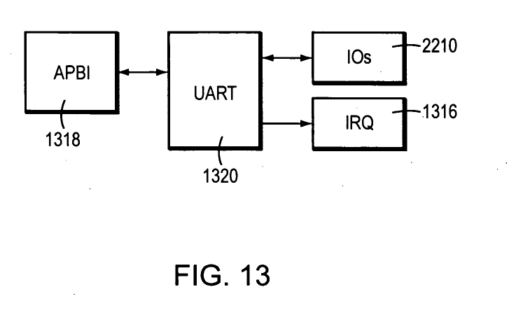

FIG. 13 illustrates UART 1320 that may be or include technology available under part number cw001203 from LSI Logic Corporation of Milpitas, Calif., and that implements UART functionality similar to that of an industry standard 16C550 UART. UART 1320 is accessible via interface 1318 and can generate interrupts at interrupt controller 1316 as a result of input/output traffic 2210 at UART 1320.

With reference to FIGS. 5, 6, now described is distributed lock management which is an example application using embedded CPU 1310. The data storage system includes an amount of memory that is shared between all directors, both front-end and back-end. In order to help ensure coherency, that is, that two directors do not access the same portion of memory simultaneously, it is necessary to lock (i.e., temporarily limit access to) areas of memory. These locks may be implemented by setting and checking the state of specified bits in predetermined locations. More particularly, by checking the state of a specified bit (set or not set) a director can determine whether the lock is already in effect. In addition, the director may test the state of this bit and set it if it is not set; in this way the director acquires the lock. The lock is released by the same director later on by clearing the specified bit.

Lock contention occurs when more than one director is trying to acquire the same lock. While a first director holds the lock a second director polls the state of the lock, i.e., periodically checks the state of the lock, to determine whether it has been released so that the second director can acquire the lock. Each time the second director polls the state of the lock it sends a separate request over the interconnection network, which can be costly. The round-trip delay incurred for each polling instance is significant and the computing resources consumed in such polling can be substantial.

However, use of the RC's embedded CPU 1310 can eliminate or help eliminate such costs, e.g., by eliminating or helping to eliminate such round-trip delays. A director may offload the polling task to CPU 1310 by sending a single message to CPU 1310 indicating which lock the director wishes to acquire. The CPU can then perform the polling for the lock, with relatively much smaller round trip delays due to the CPU's closer proximity to the memory. When the lock has been acquired on behalf of the requesting director the CPU can inform the director through another message.

The following steps may be executed to acquire a lock using embedded CPU as described above.

1. A director sends a message over fabric 14 directed to embedded CPU 1310 indicating the lock to acquire.

2. This message is routed to the message engine 718.

3. Message engine 718 places the message into global memory, increments the RX producer index, and issues an interrupt to the CPU indicating that a message has arrived.

4. Message Engine 718 sends a response to the director indicating receipt of the request.

5. As a result of the interrupt or by polling for changes in the RX producer index, CPU 1310 determines that the message has arrived.

6. Through GMI 916, CPU 1310 retrieves the message and determines which lock has been requested and by which director.

7. Through GMI 916, CPU 1310 determines whether the lock has already been taken. If the lock has been taken, CPU 1310 places the request on a queue to be serviced. If the lock has not been taken, CPU 1310 sets the lock as acquired.

8. Once the lock has been acquired for the director, CPU 1310 constructs, through GMI 916, a message in global memory indicating to the director that the director has possession of the lock.

9. CPU 1310 writes the TX producer index which indicates to message engine 916 that there is a message in memory to send.

10. Message engine 718 fetches the message from global memory and sends it over fabric 14 to the director.

11. The director receives the message and begins to operate on a portion of global memory governed by the lock.

12. Once finished with the portion of memory governed by the lock, the director sends another message to the memory that marks the lock as not taken or assigns the lock to the next requestor if present.

Other embodiments are within the scope of the following claims. For example, an RC may be implemented using multiple semiconductor packages, together with or alternatively as one or more circuit boards.

One or more of the modules of the RC may be implemented external to an ASIC that includes other modules of the RC.

The RC may include multiple embedded CPUs.

A memory controller ASIC may include one or more additional modules in addition to some or all of the modules of the RC of region 200 as described above. For example, a memory controller ASIC may have modules such that the ASIC is a superset of the RC of region 200.

The embedded CPU or CPU complex may have some or all of the processing and/or data handling capabilities of another CPU in the data storage system.

What is claimed is:

1. A data storage system comprising:
a first director being adapted for coupling to a host computer/server;
a second director being adapted for coupling to a bank of disk drives; and
a cache memory logically disposed between and communicating between the first and second directors, wherein the cache memory comprises a memory controller having an embedded central processing unit (CPU) being adapted to execute computer executable instructions.

2. The data storage system of claim 1, further comprising:
a packet switching network connecting the first and second directors and the cache memory, wherein a memory command may be sent to the memory controller over the packet switching network.

3. The data storage system of claim 1, wherein the embedded CPU is adapted to access the cache memory in response to a memory command from the first director.

4. The data storage system of claim 1, wherein the embedded CPU is adapted to access the cache memory in response to a memory command from the second director.

5. The data storage system of claim 1, wherein the memory controller is adapted to access the cache memory, independently of processing by the embedded CPU, in response to a memory command from outside the cache memory.

6. The data storage system of claim 1, wherein the embedded CPU is adapted to access the cache memory in accordance with the computer executable instructions, the computer executable instructions being stored in the cache memory.

7. The data storage system of claim 1, wherein the embedded CPU has an internal memory and is adapted to access the cache memory in accordance with the computer executable instructions, the computer executable instructions being stored in the internal memory of the CPU.

8. The data storage system of claim 1, wherein the memory controller further comprises an interface to a packet switching network.

9. The data storage system of claim 1, wherein the embedded CPU further comprises a message engine adapted to process messages directed to the embedded CPU.

10. The data storage system of claim 1, wherein the embedded CPU further comprises an interface to the cache memory.

11. A memory system comprising:
a bank of memory;
an interface to a packet switching network, the memory system being adapted to receive by the interface a packet based command to access the bank of memory; and
a memory controller being adapted to execute initialization and configuration cycles for the bank of memory, the memory controller having an embedded central processing unit (CPU) being adapted to execute computer executable instructions, the memory controller being adapted to process the packet based command.

12. The memory system of claim 1 1, wherein the embedded CPU is adapted to access the bank of memory in response to a memory command from outside the memory system.

13. The memory system of claim 11, wherein the memory controller is adapted to access the bank of memory, independently of processing by the embedded CPU, in response to a memory command from outside the memory system.

14. The memory system of claim 11, wherein the embedded CPU is adapted to access the bank of memory in accordance with the computer executable instructions, the computer executable instructions being stored in the bank of memory.

15. The memory system of claim 11, wherein the embedded CPU has an internal memory and is adapted to access the bank of memory in accordance with the computer executable instructions, the computer executable instructions being stored in the internal memory of the CPU.

16. The memory system of claim 11, wherein the embedded CPU further comprises a message engine adapted to process messages directed to the embedded CPU.

17. The memory system of claim 11, wherein the embedded CPU further comprises a direct interface to the bank of memory.

18. A memory controller comprising:
logic being adapted to execute initialization and configuration cycles for memory;
an embedded central processing unit (CPU) being adapted to execute computer executable instructions; and
an interface being adapted to access memory;
wherein the embedded CPU is adapted to access the memory in accordance with the computer executable instructions; and
wherein the memory controller is adapted to access the memory, in response to direction from outside the memory controller, independently of processing by the embedded CPU.

19. The memory system of claim 18, wherein the embedded CPU further comprises a message engine adapted to process messages directed to the embedded CPU.

20. The memory system of claim 18, wherein the embedded CPU has an internal memory and is adapted to access the bank of memory in accordance with the computer executable instructions, the computer executable instructions being stored in the internal memory of the CPU.
